(19) United States
(12) Patent Application Publication
(10) Pub. No.: US 2002/0118799 A1
(43) Pub. Date: Aug. 29, 2002

(54) Telephone answering device with enhanced voice quality

(76) Inventor: Michael J. Detlef, Vancouver, WA (US)

Correspondence Address: Kevin L. Russell, Suite 1600, 601 SW Second Ave., Portland, OR, 97204-3157, US

(21) Appl. No.: 09/797,538

(22) Filed: Feb. 28, 2001

(51) Int. Cl. H04M 1/64

(52) U.S. Cl. 379/67.1; 379/70; 379/83

(57) ABSTRACT

A telephone answering device that includes a variable rate encoder.

### BACKGROUND OF THE INVENTION

Telephone answering devices (TADs) are used throughout the world to record and store messages. Traditional TADs use an analog cassette tape to record outgoing and incoming messages. The messages are recorded in a sequential manner on the tape. After reviewing all of the messages, the tape may be rewound to the start to continue recording additional messages.

Advancements in digital technology have significantly influenced TAD designs. Instead of using an analog cassette tape to record outgoing and incoming messages, TADs are now available that use digital memory as the recording and storage medium. Digital memory storage, such as random access memory (RAM), flash memory modules, or other types of non-volatile read only memory, requires the conversion of an analog voice signal generated by a microphone or provided by an analog phone line into a corresponding digital representation.

Digital solid state memory typically has a fixed memory size. To provide sufficient recording duration for the analog voice messages, an encoding codec is employed having sufficient compression to permit the desired recording duration of the voice signal given a particular memory size. Designers of such TADs desire to minimize the necessary size of the memory to decrease the expense of the device. To reduce the memory requirements the selected voice encoding codec typically highly compresses the voice signal. Unfortunately, such high compression results in minor differences in the voice signal, typically between two different words that sound similar albeit distinct, being difficult to discern. It is difficult to decrease the compression (e.g., increase the sampling rate) while maintaining same recording duration using the same size of memory. Decreasing compression (e.g., increasing the sampling rate) while maintaining the same recording duration with the same memory size are traditionally considered contradictory.

To partially overcome the limitations inherent with the compression of the voice signals and the undesirability of increasing the available memory, some designers of TADs have used more powerful amplifiers for the speakers. It turns out that providing a more powerful amplifier is relatively inexpensive and results in somewhat more discernable speech. However, the improvement is marginal.

Karnowski, U.S. Pat. No. 5,289,529, discloses a system to improve the voice signal by modifying the dynamic range of an analog/digital converter for a digital TAD. Karnowski focuses on improving the voice encoding by using a modified automatic gain controller in the form of a voltage controlled amplifier coupled to an averaging circuit that feeds back into the voltage controlled amplifier. Unfortunately, the improvement in voice quality obtainable using an improved analog/digital converter is limited.

Falik et al., U.S. Pat. No. 5,600,821, disclose a method of managing the fragmentation of memory which occurs as individual messages are deleted out of order in a TAD. The technique taught by Falik et al. principally rewrites messages within different regions of the memory. While additional recording duration may be achieved, depending on the memory fragmentation, the voice quality remains limited to the particular voice encoding codec selected.

Akahane, U.S. Pat. No. 5,708,698, discloses a system for trimming or replacing a message that has been received and stored in a solid-state memory of a wireless voice messaging unit. The system includes playing back and marking a selected portion representing the important information in a stored message and then replacing the entire message with the selected portion. This results in increasing the available memory space for new messages. In addition, after listening to the received and stored message the user can create his own abstract of the message that is shorter than the original. The new shorter message then replaces the original message, thereby increasing the available memory space for subsequent messages. While additional recording duration may be achieved, depending on the trimming or replacement, the voice quality remains limited to the particular voice encoding codec selected.

What is desired, therefore, is a system that increases the quality of the voice encoding codec while maintaining the same ultimate recording duration with the same memory size.

### BRIEF DESCRIPTION OF THE DRAWINGS

FIG. 1 is a diagram of an exemplary embodiment of a telephone answering device.

FIG. 2. is an exemplary flow chart for a variable rate encoder for the device of FIG. 1.

FIG. 3 is an exemplary memory partition for the device of FIG. 1.

FIGS. 4A and 4B is an exemplary embodiment of the memory of FIG. 1.

### DETAILED DESCRIPTION OF THE PREFERRED EMBODIMENT

The present inventor considered the existing techniques used to achieve increased voice quality, such as for example, increased amplifier power, improved voltage controlled amplifier, rewriting messages to minimize memory fragmentation, and truncating messages. Most of these techniques are premised upon attempting to truncate unimportant portions of the message or otherwise relocating the message in the memory to permit maximum recording duration. After consideration of these techniques, the present inventor likewise considered that typical telephone answering devices include sufficient memory for approximately 20 minutes of encoded voice, while the typical user of the TAD merely needs only a few minutes of voice recording for new messages. On a regular basis the user typically listens to the new messages and thereafter erases most, if not all, of the messages which frees up memory for additional messages. Accordingly, during normal usage the TAD seldom fill up the entire, or even a major portion of, the available memory.

In light of the aforementioned considerations the present inventor determined that the compression rate for a TAD may be decreased (e.g., increasing the sampling rate) while simultaneously maintaining the same or increased recording duration with the same memory size. The decreased compression rate increases the resulting voice quality. Such seemingly contradictory goals may be achieved by including a variable rate encoder together with the TAD. To simultaneously achieve such seemingly contradictory goals, the variable rate voice encoder preferably encodes the voice signals based on criteria related to the memory usage of the TAD.

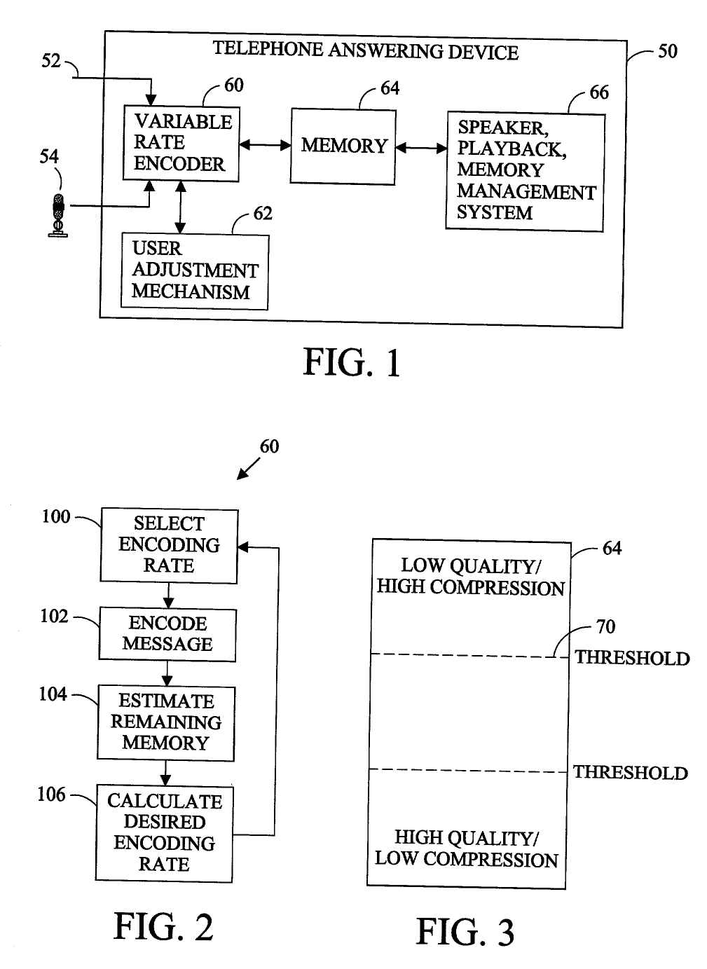

Referring to FIG. 1, the telephone answering device 50 includes a voice signal input, which may be, for example, from a digital and/or analog phone line 52 or a digital and/or analog microphone 54. It is to be understood that the voice input may be provided to the telephone answering device 50 from any source in any format. The voice input from the line 52 or the microphone 54 is provided to a variable rate encoder 60. The variable rate encoder 60 is designed such that the amount of memory required to store a particular compressed voice message varies based upon the adjustment of the variable rate encoder 60. In other words, if the compression rate is modified for a particular voice message the amount of memory required is different than it would have been had the compression rate remained the same. Normally, as the compression rate is increased the amount of memory required to store the resulting data is less than it would have been if the compression rate remained the same or was decreased. The variable rate encoder 60 may adjust the compression rate (e.g., or otherwise the resulting memory required to store the resulting data) by modification of the codec, changing the codec itself, or by any other technique.

A user adjustment mechanism 62 permits the user to adjust the compression rate (or other suitable parameter) of the variable rate encoder 60. If the user selects a relatively high compression rate, then the duration of the voice messages that may be recorded in an associated memory 64 is increased. In contrast, if the user selects a relatively low compression rate then the duration of the voice messages that may be recorded in the memory 64 is decreased. However, with a relatively low compression rate the voice quality is typically increased. In this embodiment, the user may adjust the variable rate encoder 60 so that the voice messages have the desired quality. The user adjustment mechanism may include a visual indication of the estimated quality of the encoded voice signal at the selected encoding rate, the estimated total time remaining for recording additional encoded voice signal messages at the selected encoding rate, and the estimated total time potentially available for recording encoded voice signal messages at the selected encoding rate. In addition, the variable rate encoder 60 may be adjusted for subsequently received messages thereby leaving the existing messages at a different (or multiple) compression rates. In essence, the user adjustment mechanism may adjust the adjustable compression rate for a second signal representative of a voice message while being free from adjusting the compression rate for the first signal. Accordingly, as the memory 64 is being used the user may adjust the compression rate to permit additional messages to be stored within the memory 64, including those that would not have otherwise fit within the memory 64. A speaker, playback, and memory management system 66 controls the remaining features of the TAD 50, such as for example, deleting messages, saving messages, listening to messages, setting preferences, etc.

The user adjustment mechanism 62 may likewise be implemented in such a manner that it indicates the estimated total time available for recording messages, or otherwise the time remaining for recording messages based on the length of messages already recorded in the memory. This indication may be in addition to any other indications, such as the number of messages. This permits the user to more properly select whether or not to delete selected messages to make memory available for other messages. In addition, the estimated total time remaining for recording new messages or estimated total time used for existing messages may be implemented in any suitable system, with or without variable rate encoding.

Referring to FIG. 2, in another embodiment, the variable rate encoder 60 may set an initial encoding rate 100 (or otherwise select a suitable codec) and encode a message 102. The variable rate encoder 60 then determines an estimate of the remaining available memory at block 104. Based on the estimated remaining available memory (or the actual available memory) the variable rate encoder 60 calculates, preferably based on a set of rules, a desired encoding rate at block 106 for the next message. The set of rules (if employed) may be, for example, based on (1) an estimate of the remaining available memory (or actual remaining available memory), (2) an estimate of the used memory (or actual used memory), (3) a set of one or more memory or duration based thresholds after which the encoding rate is modified, and (4) the number of messages that are recorded. In addition, the rules may include a percentage or other statistical measure of the size of the memory or time remaining in the memory. In this manner, if the memory is replaced with a different sized memory, then the system may automatically adjust to accommodate. For example, the threshold may be set at 80% of the total duration of messages that may be stored in the memory or 80% of the memory, which when exceeded, the compression rate would be modified.

Referring to FIG. 3, in another embodiment, the memory 64 may include a threshold level 70 based on memory or duration of recording after which the same or additional messages are recorded at an increased compression rate. The threshold level 70 may be based on any suitable measure. In addition, the system may include multiple threshold levels. In this manner, the effective voice recording duration may be increased, while simultaneously permitting the predominant number (or duration) of messages to be recorded at increased quality. In addition, the system may be designed such that a predetermined total duration of voice messages may be recorded, with the threshold(s) being adjusted such that the total duration is achieved.

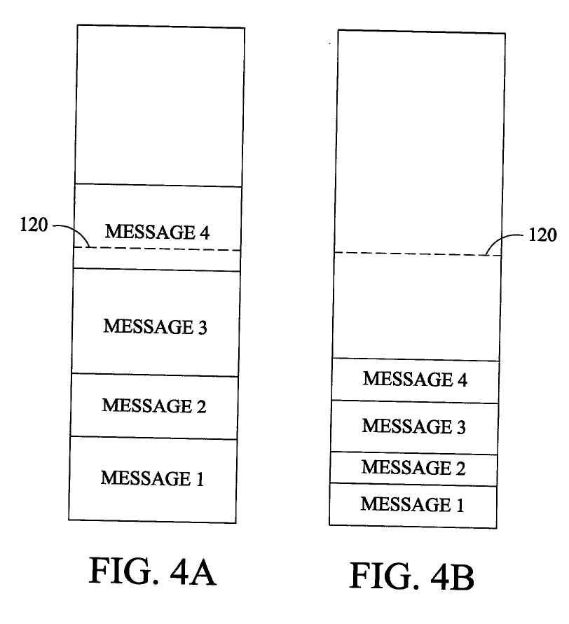

Referring to FIG. 4A, in another embodiment, the variable rate encoder 60 may re-compress recorded messages to decrease the memory required to store the message. If a message is re-compressed the original message is replaced with the re-compressed message. In one example, the encoder 60 may re-compress one or more of the messages when the total currently recorded messages exceeds a memory threshold 120 or total duration of recording. After re-compression of one or more of the messages additional memory will be available for additional messages. Referring to FIG. 4B, the re-compression of one or more of the messages at a higher compression rate results in the freeing up memory for additional messages. If desired, one, or more messages, or portions thereof, may be re-compressed at a higher compression rate, as desired.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

What is claimed is:

1. A telephone answering device comprising:
(a) an encoder suitable to receive a first signal representative of a voice message;
(b) said encoder compressing said first signal using an adjustable compression rate; and
(c) a memory suitable for storing said compressed first signal.

2. The device of claim 1 further comprising a speaker for listening to a voice message representative of said first compressed signal.

3. The device of claim 1 wherein the amount of memory required to store said first signal varies based upon said adjustable compression rate.

4. The device of claim 1 wherein the amount of memory required to store said compressed first signal is different than it would have been had the compression rate been different.

5. The device of claim 1 wherein said first signal is from an analog phone line.

6. The device of claim 1 wherein said first signal is from a digital phone line.

7. The device of claim 1 wherein said first signal is digital.

8. The device of claim 1 wherein said first signal is analog.

9. The device of claim 1 wherein said adjustable compression rate is adjusted by modification of the codec of said encoder.

10. The device of claim 1 wherein said adjustable compression rate is adjusted by changing to a different codec.

11. The device of claim 1 wherein said adjustable compression rate is adjusted by changing a parameter of said encoder.

12. The device of claim 1 further comprising a memory management system that adjusts said adjustable compression rate based at least in part upon at least a user adjustment mechanism.

13. The device of claim 12 wherein said user adjustment mechanism includes at least an indication of the estimated quality of the encoded voice signal at the selected encoding rate.

14. The device of claim 12 wherein said user adjustment mechanism includes at least an indication of the estimated total time remaining for recording additional encoded voice signal messages at the selected encoding rate.

15. The device of claim 12 wherein said user adjustment mechanism includes at least an indication of the estimated total time potentially available for recording encoded voice signal messages at the selected encoding rate.

16. The device of claim 12 wherein said user adjustment mechanism adjusts said adjustable compression rate for a second signal representative of a voice message while being free from adjusting the compression rate for said first signal.

17. The device of claim 1 further comprising a memory management system that adjusts said adjustable compression rate based at least in part upon an estimate of the total time remaining for recording additional encoded voice signal messages.

18. The device of claim 1 further comprising a memory management system that adjusts said adjustable compression rate based at least in part upon an estimate of the total time potentially available for recording encoded voice signal messages at the selected encoding rate.

19. The device of claim 1 further comprising a memory management system that adjusts said adjustable compression rate based at least in part upon a threshold.

20. The device of claim 19 wherein said threshold is a memory threshold.

21. The device of claim 19 wherein said threshold is based on the number of currently recorded messages stored in said memory.

22. The device of claim 19 wherein said threshold is based on the duration of currently recorded messages stored in memory.

23. The device of claim 19 wherein said threshold is based on a statistical measure of at least one of the size of the memory and time remaining in the memory

24. The device of claim 19 further comprising another threshold based upon which said memory management system adjusts said adjustable compression rate.

25. The device of claim 1 wherein said memory includes said first message encoded at a first rate and a second message representative of a voice message encoded at a second rate.

26. The device of claim 1 wherein device re-compresses said first message at a different rate and stores said re-compressed first message in said memory.

27. The device of claim 26 wherein said re-compression occurs based on a threshold.

28. The device of claim 26 wherein a plurality of messages representative of a voice message are re-compressed and said plurality of re-compressed messages are stored in said memory.

29. The device of claim 26 wherein said re-compression occurs based on the number of messages stored in said memory.

30. A method of operating a telephone answering device comprising:
(a) an encoder receiving a first signal representative of a voice message;
(b) said encoder compressing said first signal using an adjustable compression rate; and
(c) storing said compressed first signal in a memory.

31. The method of claim 30 further comprising listening to a voice message representative of said first compressed signal using a speaker.

32. The method of claim 30 wherein the amount of memory required to store said first signal varies based upon said adjustable compression rate.

33. The method of claim 30 wherein the amount of memory required to store said compressed first signal is different than it would have been had the compression rate been different.

34. The method of claim 30 wherein said first signal is from an analog phone line.

35. The method of claim 30 wherein said first signal is from a digital phone line.

36. The method of claim 30 wherein said first signal is digital.

37. The method of claim 30 wherein said first signal is analog.

38. The method of claim 30 wherein said adjustable compression rate is adjusted by modification of the codec of said encoder.

39. The method of claim 30 wherein said adjustable compression rate is adjusted by changing to a different codec.

40. The method of claim 30 wherein said adjustable compression rate is adjusted by changing a parameter of said encoder.

41. The method of claim 30 further comprising adjusting said adjustable compression rate based at least in part upon at least a user adjustment mechanism.

42. The method of claim 41 further including at least an indication of the estimated quality of the encoded voice signal at the selected encoding rate.

43. The method of claim 41 further including at least an indication of the estimated total time remaining for recording additional encoded voice signal messages at the selected encoding rate.

44. The method of claim 41 further including at least an indication of the estimated total time potentially available for recording encoded voice signal messages at the selected encoding rate.

45. The method of claim 41 further including adjusting said adjustable compression rate for a second signal representative of a voice message while being free from adjusting the compression rate for said first signal.

46. The method of claim 30 further comprising adjusting said adjustable compression rate based at least in part upon an estimate of the total time remaining for recording additional encoded voice signal messages.

47. The method of claim 30 further comprising adjusting said adjustable compression rate based at least in part upon an estimate of the total time potentially available for recording encoded voice signal messages at the selected encoding rate.

48. The method of claim 30 further comprising adjusting said adjustable compression rate based at least in part upon a threshold.

49. The method of claim 48 wherein said threshold is a memory threshold.

50. The method of claim 48 wherein said threshold is based on the number of currently recorded messages stored in said memory.

51. The method of claim 48 wherein said threshold is based on the duration of currently recorded messages stored in memory.

52. The method of claim 48 wherein said threshold is based on a statistical measure of at least one of the size of the memory and time remaining in the memory

53. The method of claim 48 further comprising another threshold based upon which said memory management system adjusts said adjustable compression rate.

54. The method of claim 30 wherein said memory includes said first message encoded at a first rate and a second message representative of a voice message encoded at a second rate.

55. The method of claim 30 further comprising compressing said first message at a different rate and stores said re-compressed first message in said memory.

56. The device of claim 55 wherein said re-compression occurs based on a threshold.

57. The device of claim 55 wherein a plurality of messages representative of a voice message are re-compressed and said plurality of re-compressed messages are stored in said memory.

58. The device of claim 55 wherein said re-compression occurs based on the number of messages stored in said memory.

59. A telephone answering device comprising:
(a) an encoder suitable to receive a first signal representative of a voice message;
(b) said encoder compressing said first signal;
(c) a memory suitable for storing said compressed first signal; and
(d) an indicator indicating at least one of the estimated total time remaining for recording additional messages and estimated total time used for existing messages.

60. The device of claim 59 wherein said indicator indicates said estimated total time remaining for recording additional messages.

61. The device of claim 59 wherein said indicator indicates said estimated total time used for existing messages.

62. A method of operating a telephone answering device comprising:
(a) an encoder receiving a first signal representative of a voice message;
(b) said encoder compressing said first signal;
(c) storing said compressed first signal in a memory; and
(d) indicating at least one of the estimated total time remaining for recording additional messages and estimated total time used for existing messages.

63. The method of claim 62 wherein said indicator indicates said estimated total time remaining for recording additional messages.

64. The method of claim 62 wherein said indicator indicates said estimated total time used for existing messages.
